(19) United States
(12) Patent Application Publication
(10) Pub. No.: US 2024/0340380 A1
(43) Pub. Date: Oct. 10, 2024

(54) IMAGE INSPECTION APPARATUS, PRINTING SYSTEM, AND IMAGE INSPECTION METHOD

(71) Applicant: Kazuhiro IJICHI, Kanagawa (JP)

(72) Inventor: Kazuhiro IJICHI, Kanagawa (JP)

(21) Appl. No.: 18/631,553

(22) Filed: Apr. 10, 2024

(30) Foreign Application Priority Data
Apr. 10, 2023 (JP) 2023-063517
Feb. 6, 2024 (JP) 2024-016490

(51) Int. Cl. H04N 1/00; G06T 7/00; G06T 7/62

(52) U.S. Cl. CPC H04N 1/00074; G06T 7/001; G06T 7/62; H04N 1/00005; H04N 1/00037; H04N 1/00045; G06T 2207/30144

(57) ABSTRACT

An image inspection apparatus includes processing circuitry. The processing circuitry acquires inspection target image data. The processing circuitry compares the acquired inspection target image data with comparison image data to detect a plurality of regions of an inspection target image as a plurality of detection target images. The processing circuitry merges a plurality of display frames indicating the plurality of regions detected as the plurality of inspection target images, which are determined to overlap, into a display frame after merge. The processing circuitry displays the display frame after merge on the inspection target image. The display frame includes the plurality of regions detected as the plurality of detection target images.

### CROSS-REFERENCE TO RELATED APPLICATIONS

This patent application is based on and claims priority pursuant to 35 U.S.C. § 119(a) to Japanese Patent Application No. 2023-063517, filed on Apr. 10, 2023, and 2024-016490, filed on Feb. 6, 2024, in the Japan Patent Office, the entire disclosure of which is hereby incorporated by reference herein.

### BACKGROUND

### Technical Field

Embodiments of the present disclosure relate to an image inspection apparatus, a printing system, and an image inspection method.

### Related Art

Image inspection apparatuses are known to detect a region of a detection target image (e.g., a region having a difference from a comparison image) from an inspection target image and displays the inspection target image in which the region of the detection target image is indicated by a display frame.

A print inspection apparatus is known that specifies a defective region from an inspection target image and displays the inspection target image in which the defective region is indicated by a rectangle.

### SUMMARY

Embodiments of the present disclosure described herein provide image inspection apparatus including processing circuitry. The processing circuitry acquires inspection target image data. The processing circuitry compares the acquired inspection target image data with comparison image data to detect a plurality of regions of an inspection target image as a plurality of detection target images. The processing circuitry merges a plurality of display frames indicating the plurality of regions detected as the plurality of inspection target images, which are determined to overlap, into a display frame after merge. The processing circuitry displays the display frame after merge on the inspection target image. The display frame includes the plurality of regions detected as the plurality of detection target images. Embodiments of the present disclosure described herein provide a novel printing system including a printer to print an image on a recording medium and processing circuitry. The processing circuitry acquires inspection target image data from an inspection target image that is read from the printed image. The processing circuitry compares the acquired inspection target image data with comparison image data that is image data used for printing the printed image, to detect a plurality of regions of an inspection target image as a plurality of detection target images. The processing circuitry merges a plurality of display frames indicating the plurality of regions detected as the plurality of inspection target images, which are determined to overlap, into a display frame after merge. The processing circuitry displays the display frame after merge on the inspection target image. The display frame includes the plurality of regions detected as the plurality of detection target images.

Embodiments of the present disclosure described herein provide a novel image inspection method. The method includes: acquiring inspection target image data; comparing the acquired inspection target image data with comparison image data to detect a plurality of regions of an inspection target image as a plurality of detection target images; merging a plurality of display frames indicating the plurality of regions detected as the plurality of inspection target images, which are determined to overlap, into a display frame after merge; and displaying the display frame after merge on the inspection target image, the display frame including the plurality of regions detected as the plurality of detection target images.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image inspection system according to an embodiment of the present disclosure;

FIG. 2 is a diagram illustrating a hardware configuration of an image inspection apparatus of the image inspection system of FIG. 1;

FIG. 3 is a diagram illustrating a hardware configuration of the image forming apparatus of the image inspection system of FIG. 1;

FIG. 4 is a diagram illustrating a functional configuration of an image inspection apparatus according to an embodiment of the present disclosure;

FIG. 5 is a flowchart of a procedure of a display control unit according to an embodiment of the present disclosure;

FIG. 6A and FIG. 6B are diagrams illustrating processes of temporarily generating a defective frame, according to an embodiment of the present disclosure;

FIG. 7 is a diagram illustrating processes of determining whether display frames overlap, according to an embodiment of the present disclosure;

FIG. 8 is a diagram illustrating a merge and re-merge of temporary display frame according to an embodiment of the present disclosure;

FIG. 9 is a flowchart of display frame merge processing in step S14 of FIG. 5, according to an embodiment of the present disclosure;

FIG. 10 is a flowchart of a process to merge overlapped display frames in step S22 of FIG. 9, according to an embodiment of the present disclosure;

FIGS. 11A and 11B are diagrams illustrating processes of generating a display image, according to an embodiment of the present disclosure;

FIGS. 12A and 12B are other diagrams illustrating processes of generating a display image, according to an embodiment of the present disclosure;

FIG. 13 is another diagram illustrating processes of generating a display image, according to an embodiment of the present disclosure;

FIG. 14 is a flowchart of processes performed by a determination unit according to an embodiment of the present disclosure;

FIG. 15 is a diagram illustrating a functional configuration of an image forming apparatus according to an embodiment of the present disclosure; and

FIG. 16 is a diagram illustrating a configuration of a printing system including an image forming apparatus and an image inspection apparatus, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of several embodiments of the present disclosure with reference to the drawings.

### First Embodiment

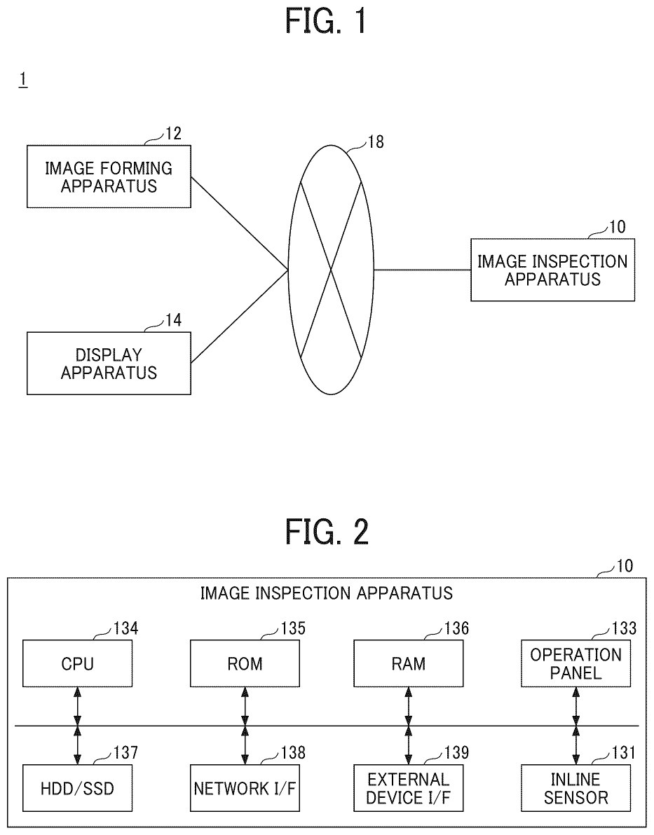

FIG. 1 is a diagram illustrating an overall configuration of an image inspection system 1 according to an embodiment of the present disclosure.

The image inspection system 1 of FIG. 1 includes an image inspection apparatus 10, an image forming apparatus 12, and a display apparatus 14. The image inspection apparatus 10, the image forming apparatus 12, and the display apparatus 14 are connected to each other via a network 18 and communicate with each other. The network 18 is, for example, the Internet or a local area network (LAN).

The image forming apparatus 12 is an example of an apparatus that uses image data to print an inspection target image on a recording medium such as a sheet. The image forming apparatus 12 is, for example, a color production printer, a laser printer, an inkjet printer, or a multifunction printer.

The image inspection apparatus 10 is an example of an apparatus that inspects the inspection target image. The display apparatus 14 is an example of a device that displays the result of inspection performed by the image inspection apparatus 10. The display apparatus 14 may be a personal computer (PC), a tablet computer, or a smartphone. The display apparatus 14 may be a device having a display function, such as a display not connected to the network 18.

The image inspection apparatus 10 acquires the inspection target image data of the inspection target image printed on a recording medium such as a sheet. The image inspection apparatus 10 acquires comparison image data that is image data used for printing the inspection target image on a recording medium such as a sheet.

The image inspection apparatus 10 compares the acquired inspection target image data with the comparison image data, and detects a region of a detection target image such as a defect from the inspection target image data. The image inspection apparatus 10 displays a display frame to be described later, indicating the region of the detection target image, on the display apparatus 14, as an inspection result. For example, the display apparatus 14 displays the inspection target image with which the display frame to be described later, indicating the region of the detection target image overlaps under the control of the image inspection apparatus 10.

The configuration of the information forming system 1 illustrated in FIG. 1 is just one example. For example, the image inspection system 1 may include other devices. Alternatively, the image inspection system 1 may have a configuration in which the image forming apparatus 12 is not included. Alternatively, the image inspection apparatus 10 and the display apparatus 14 may be integrated in the image inspection system 1.

FIG. 2 is a diagram illustrating a hardware configuration of the image inspection apparatus 10 of the image inspection system 1. The image inspection apparatus 10 of FIG. 2 includes an inline sensor 131, an operation panel 133, a central processing unit (CPU) 134, a read-only memory (ROM) 135, a random-access memory (RAM) 136, a hard disk drive (HDD)/solid-state drive (SSD) 137, a network interface (I/F) 138, and an external device I/F 139. For example, the CPU 134, the ROM 135, the RAM 136, the HDD/SSD 137, the network I/F 138, and the external device I/F 139 are configured by a computer.

The CPU 134 reads programs stored in the ROM 135 or the HDD/SSD 137 and stores the programs in the RAM 136. Then, the CPU 134 executes various processes in accordance with the programs stored in the RAM 136. The processes executed by the CPU 134 are described later.

The ROM 135 is a non-volatility auxiliary memory device. The ROM 135 stores programs such as a basic input/output system (BIOS) that is programed basic operations of the image inspection apparatus 10. The RAM 136 is a volatile primary memory and is used as a working area for the CPU 134. The operation panel 133 is an example of a device that displays information to a user and receives an operation from the user. The HDD/SSD 137 is a large capacity non-volatility auxiliary memory device. The HDD/SSD 137 stores, for example, the inspection target image data read from printed materials, the comparison image data used for printing, programs for various processes to be described later, and setting information.

The network I/F 138 is, for example, a LAN card, and is used for the communication via the network 18. The external device I/F 139 is used for communication with an external device.

The inline sensor 131 reads an image (inspection target image) printed on a recording medium such as a sheet. The inline sensor 131 includes a light source and a line image sensor. The line image sensor includes a plurality of imaging elements aligned one dimensionally in the width direction of a sheet. The imaging elements irradiate the sheet passing over a reading position with the light emitted from the light source, and photoelectrically converts and reads the light reflected from the sheet for each pixel.

The inline sensor 131 reads the image printed on the sheet as the inspection target image by repeatedly performing an operation of reading the image for one line in the width direction of the sheet, in accordance with the sheet passing operation over the reading position.

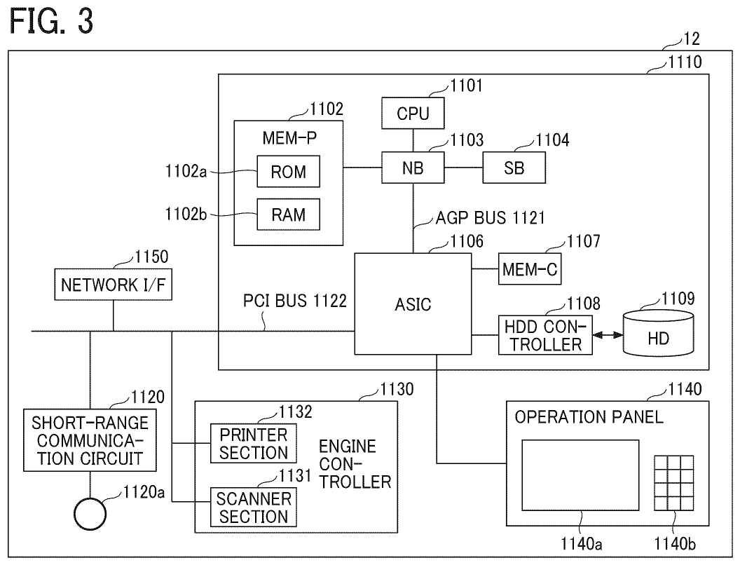

FIG. 3 is a diagram illustrating a hardware configuration of the image forming apparatus 12 of the image inspection system 1.

The image forming apparatus 12 includes a controller 1110, a short-range communication circuit 1120, an engine controller 1130, an operation panel 1140, and a network I/F 1150.

The controller 1110 includes a CPU 1101 as a main component of a computer, a system memory (MEM-P) 1102, a north bridge (NB) 1103, a south bridge (SB) 1104, an application specific integrated circuit (ASIC) 1106, a local memory (MEM-C) 1107 as a storage device, an HDD controller 1108, and a hard disk (HD) 1109 as a storage device.

The NB 1103 and the ASIC 1106 are connected with each other via an accelerated graphics port (AGP) bus 1121. The CPU 1101 is a processor that controls the overall operation of the image forming apparatus 12. The NB 1103 is a bridge to connect the CPU 1101, the MEM-P 1102, the SB 1104, and the AGP bus 1121. The NB 1103 includes a memory controller that controls reading from and writing to the MEM-P 1102, a peripheral component interconnect (PCI) master, and an AGP target.

The MEM-P 1102 includes a ROM 1102a and a RAM 1102b. The ROM 1102a is a memory to store programs and data for implementing various functions of the controller 1110. The RAM 1102b is a memory to deploy programs, data or to render print data for memory printing. The program stored in the RAM 1102b may be provided as a file in an installable format or an executable format that the program is recorded in a computer-readable storage medium such as a compact disc-read-only memory (CD-ROM), a compact disc-recordable (CD-R), or a digital versatile disc (DVD).

The SB 1104 is a bridge to connect the NB 1103 to PCI devices and peripheral devices. The ASIC 1106 is an integrated circuit (IC) for image processing having a hardware element for image processing and has a role of a bridge that connects the AGP bus 1121, a PCI bus 1122, the HDD controller 1108, and the MEM-C 1107 to each other.

The ASIC 1106 includes a PCI target, an AGP master, an arbiter (ARB) serving as a core of the ASIC 1106, a memory controller that controls the MEM-C 1107, a plurality of direct memory access controllers (DMAC) that rotates image data by hardware logic, and a PCI unit that transfers data between a scanner section 1131 and a printer section 1132 via the PCI bus 1122. A connection to the ASIC 1106 may be established through a universal serial bus (USB) interface or an Institute of Electrical and Electronics Engineers 1394 (IEEE 1394) interface.

The MEM-C 1107 is a local memory used as a copy image buffer and a code buffer. The HD 1109 is a memory device that stores image data, font data used in printing, and forms. The HD 1109 controls the reading or writing of data from or to the HD 1109 under the control of the CPU 1101.

The AGP bus 1121 is a bus interface for a graphics accelerator card that has been proposed to speed up graphics processing. The AGP bus 1121 is a bus that allows direct access to the MEM-P 1102 at high throughput to speed up the graphics accelerator card.

The short-range communication circuit 1120 includes a short-range communication antenna 1120a. The short-range communication circuit 1120 is a communication circuit that communicates in compliance with the near field radio communication (NFC) or the Bluetooth®. The engine controller 1130 includes the scanner section 1131 and the printer section 1132. The operation panel 1140 includes a panel display 1140a and hard keys 1140b. The panel display 1140a is, for example, a touch screen that displays current settings or a selection screen and receives a user input. The hard keys 1140b include, for example, a numeric keypad and a start key. The numeric keypad receives setting values of image forming parameters such as an image density parameter. The start key receives an instruction to start copying.

The controller 1110 controls the overall operation of the image forming apparatus 12 and controls, for example, drawing, communication, and input through the operation panel 1140. The scanner section 1131 reads an image formed on a recording medium such as a sheet and generates image data. The printer section 1132 transfers an image using a color material such as a toner image onto the recording medium such as the sheet, and fixes the transferred image on the recording medium such as the sheet, to perform image formation on the recording medium such as the sheet.

The network I/F 1150 is an interface for performing data communication using the network 18. The short-range communication circuit 1120 and the network I/F 1150 are electrically connected to the ASIC 1106 via the PCI bus 1122.

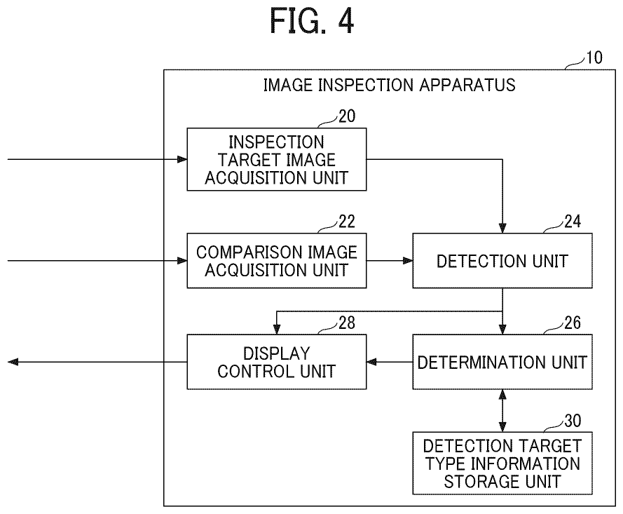

FIG. 4 is a diagram illustrating a functional configuration of the image inspection apparatus 10 according to an embodiment of the present disclosure. The image inspection apparatus 10 includes an inspection target image acquisition unit 20, a comparison image acquisition unit 22, a detection unit 24, a determination unit 26, a display control unit 28, and a detection target type information storage unit 30. The inspection target image acquisition unit 20, the comparison image acquisition unit 22, the detection unit 24, the determination unit 26, the display control unit 28, and the detection target type information storage unit 30 are implemented by the CPU 134 of the image inspection apparatus 10 executing the processes defined in the programs stored in, for example, the ROM 135.

The inspection target image acquisition unit 20 acquires inspection target image data. For example, the inline sensor 131 reads an image from a recording medium such as a sheet printed by the image forming apparatus 12, and the inspection target image acquisition unit 20 acquires inspection target image data of the inspection target image.

The comparison image acquisition unit 22 acquires comparison image data. The comparison image data is the image data used by the image forming apparatus 12 to print an image on a recording medium such as a sheet. The image data used by the image forming apparatus 12 to print the image on the recording medium such as the sheet is, for example, print original data. The comparison image acquisition unit 22 acquires the comparison image data from the image forming apparatus 12 that has printed the image on the recording medium such as the sheet.

The detection unit 24 compares the inspection target image data acquired by the inspection target image acquisition unit 20 with the comparison image data acquired by the comparison image acquisition unit 22, and detects a region of the detection target image such as a defect from the inspection target image data.

For example, the detection unit 24 compares the inspection target image data with the comparison image data for each corresponding pixel to calculate a difference value and detects the region of the detection target image such as a defective region from the inspection image based on a magnitude relation between the difference value and a threshold value. In the present embodiment, cases in which the region of the detection target image is a defective region are described. The comparison image data functions as correct image data when the image forming apparatus 12 correctly prints the image. The defective region is a region different from a comparison image in the inspection target image. The threshold value is information (value) serving as a criterion for determining the presence or absence of a defect in the inspection target image.

The detection unit 24 detects information on the coordinates, color, or shape of the defect as information to detect a defect. In the following description, it is assumed that the coordinates of a defect are the diagonal coordinates of a rectangle circumscribing the defect, the colors of the defect are white and black, and the shapes of the defect are granular and linear.

The display control unit 28 generates display image data for notifying the user of a detected defective region, and causes the display apparatus 14 to display the display image data. For example, the display control unit 28 superimposes a display frame indicating the detected defective region on the inspection target image. The display control unit 28 generates display image data used to display a display frame with no overlap, which is achieved by merging overlapping display frames, in place of overlapping display frames. Details of the process of the display control unit 28 are described later.

The determination unit 26 determines the type of the detection target image detected by the detection unit 24. The detection target type information used by the determination unit 26 to determine the type of the detection target image is registered in advance in the detection target type information storage unit 30. For example, when the region of the detection target image is a defective region, the detection target type information storage unit 30 registers in advance the type of defect such as a single defect, a granular defect, and a linear defect, and information for determining the type of defect. The type of the detection target image determined by the determination unit 26 is displayed in association with the display frame as described later. Details of the process of the determination unit 26 are described below.

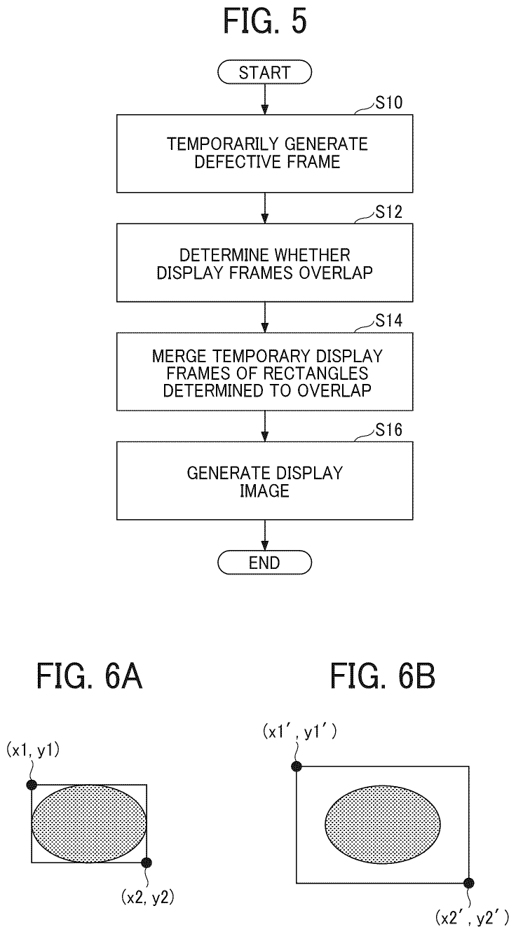

FIG. 5 is a flowchart of a procedure of the display control unit 28 according to an embodiment of the present disclosure.

In step S10, the display control unit 28 temporarily generates a defective frame. FIG. 6A and FIG. 6B are diagrams illustrating processes of temporarily generating a defective frame, according to an embodiment of the present disclosure. FIG. 6A illustrates an example of coordinates of a defect detected by the detection unit 24, and illustrates diagonal coordinates (x1, y1) and (x2, y2) of a rectangle circumscribing the defect. When the rectangle in FIG. 6A is displayed as the display frame indicating the region of the detection target image, the defect and the display frame are connected to each other, and thus the defect may be difficult to recognize. The display control unit 28 expands, for example, the rectangle of FIG. 6A as illustrated in FIG. 6B. The diagonal coordinates (x1′, y1′) and (x2′, y2′) of the rectangle in FIG. 6B are obtained by expanding the rectangle in FIG. 6A by a predetermined size, for example, 10 pixels. The display control unit 28 temporarily generates a defective frame for all the defects detected by the detection unit 24.

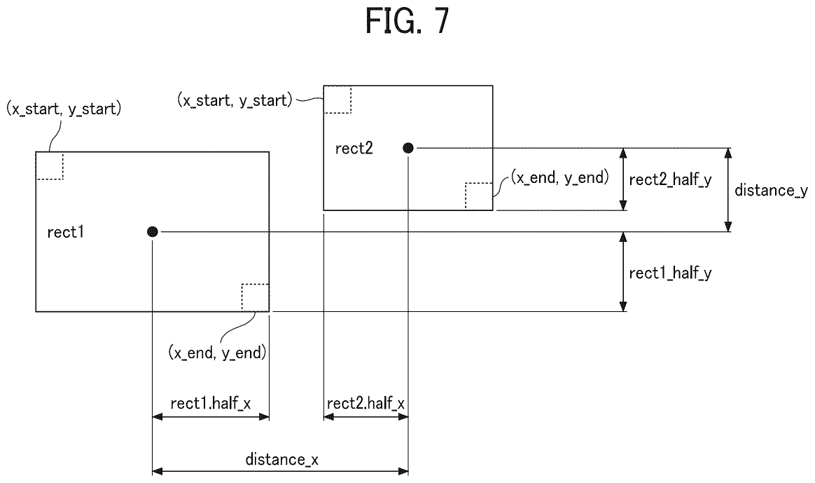

In step S12, the display control unit 28 determines whether display frames overlap. FIG. 7 is a diagram illustrating processes of determining whether display frames overlap, according to an embodiment of the present disclosure. The display control unit 28 determines whether the rectangular display frames (temporary display frames) temporarily generated in step S10 overlap each other. Whether two rectangles overlap can be determined by the following equation based on the distance between the centers of the two rectangles and the sizes of the rectangles.

In the following description, the two rectangles are referred to as “rect1” and “rect2”. The coordinates of the upper left corner of each rectangle are referred to as (x_start, y_start), and the coordinates of the lower right corner are referred to as (x_end, y_end).

The distance between the centers of the two rectangles is calculated by the following equation.

$$\\ distance\_x = \vert ( rect 1 \cdot x\_start + rect 1 \cdot x\_end ) / 2 - ( rect 2 \cdot x\_start + rect 2 \cdot x\_end ) / 2 \vert$$

$$\\ distance\_y = \vert ( rect 1 \cdot y\_start + rect 1 \cdot y\_end ) / 2 - ( rect 2 \cdot y\_start + rect 2 \cdot y\_end ) / 2 \vert$$

The half-length of each of the two sides of the rectangle is calculated by the following equation.

$$\\ rect 1 \cdot half\_x = ( rect 1 \cdot x\_end - rect 1 \cdot x\_start + 1 ) / 2$$

$$\\ rect 1 \cdot half\_y = ( rect 1 \cdot y\_end - rect 1 \cdot y\_start + 1 ) / 2$$

$$\\ rect 2 \cdot half\_x = ( rect 2 \cdot x\_end - rect 2 \cdot x\_start + 1 ) / 2$$

$$\\ rect 2 \cdot half\_y = ( rect 2 \cdot y\_end - rect 2 \cdot y\_start + 1 ) / 2$$

When the two rectangles are horizontally adjacent, the horizontal distance between centers is calculated by the following equation.

$$\\ adjoin\_x = rect 1 \cdot half\_x + rect 2 \cdot half\_x$$

When the two rectangles are vertically adjacent, the vertical distance between centers is calculated by the following equation.

$$\\ adjoin\_y = rect 1 \cdot half\_y + rect 2 \cdot half\_y$$

When the following conditional expression is satisfied, the display control unit 28 determines that the two rectangles overlap. The following conditional expression represents a condition that the distance “distance_x” between the centers of the two rectangles is equal to or less than the horizontal distance between centers “admit_x” and the distance “distance_y” between the centers of the two rectangles is equal to or less than the vertical distance between centers “admit_y”.

$$\\ ( distance\_x <= adjoin\_x ) \&\& ( distance\_y <= adjoin\_y )$$

In step S14, the display control unit 28 merges the temporary display frames of the rectangles determined to overlap in step S12. The display control unit 28 calculates the region of the rectangle “integrated_rect” after merge by the following equation.

$$\\ integrated\_rect \cdot x\_start = min ( rect 1 \cdot x\_start , rect 2 \cdot x\_start )$$

$$\\ integrated\_rect \cdot y\_start = min ( rect 1 \cdot y\_start , rect 2 \cdot y\_start )$$

$$\\ integrated\_rect \cdot x\_end = max ( rect 1 \cdot x\_end , rect 2 \cdot x\_end )$$

$$\\ integrated\_rect \cdot y\_end = max ( rect 1 \cdot y\_end , rect 2 \cdot y\_end )$$

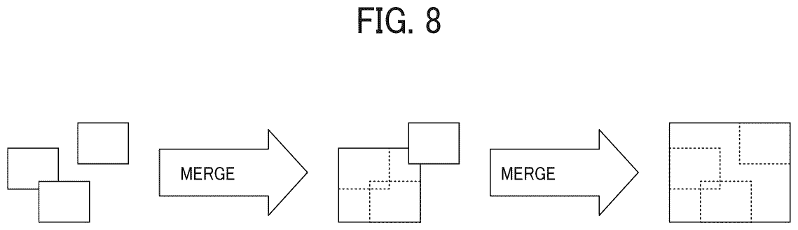

The “min” above represents obtaining the minimum value from the elements in the parenthesis. The “max” represents obtaining the maximum value from the element in the parenthesis. The display control unit 28 executes the display frame merge processing to merge the overlapped temporary display frames in step S14, and sets the circumscribed rectangles as the merged temporary display frames. When the temporary display frame after merge newly overlaps other temporary display frame, the temporary display frames are merged, for example, as illustrated in FIG. 8. FIG. 8 is a diagram illustrating a merge and a re-merge of temporary display frame according to an embodiment of the present disclosure. The display control unit 28 repeats the merge and re-merge process until the number of temporary display frames converges.

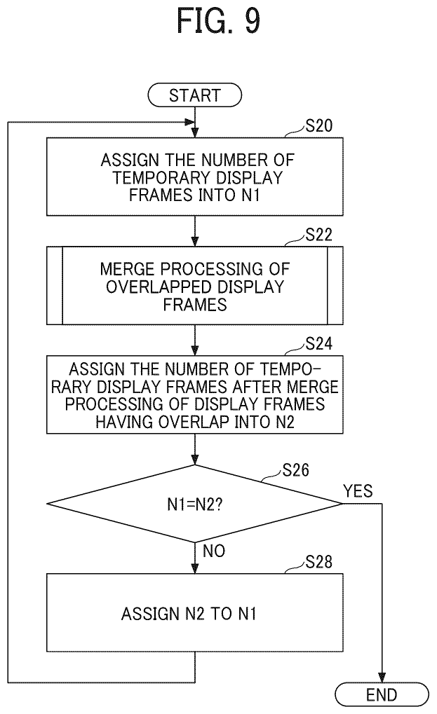

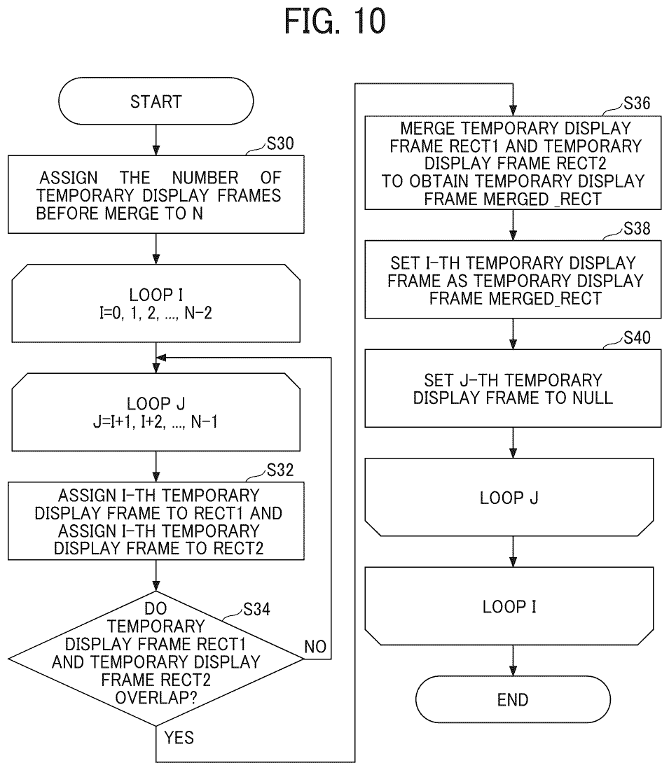

FIG. 9 is a flowchart of display frame merge processing in step S14 of FIG. 5, according to an embodiment of the present disclosure. In step S20, the display control unit 28 assigns the number of temporary display frames to “N1”. In step S22, the display control unit 28 executes merge processing of the overlapped display frames.

FIG. 10 is a flowchart of a process to merge overlapped display frames in step S22 of FIG. 9, according to an embodiment of the present disclosure. In step S30, the display control unit 28 assigns the number of temporary display frames to “N” before merge.

In steps S32 to S34, the display control unit 28 finds two temporary display frames “rect1” and “rect2” that overlap in the loop processing of the loops i and j. The display control unit 28 executes the processing of steps S36 to S40 for the two temporary display frames the “rect1” and the “rect2” that overlap. In step S36, the display control unit 28 integrates the two temporary display frames the “rect1” and the “rect2” that overlap to obtain a temporary display frame “integrated_rect”. In step S38, the display control unit 28 sets the i-th temporary display frame as the temporary display frame “integrated_rect” after merge. The display control unit 28 sets the j-th temporary display frame to “NULL” that indicates no display frame. As described above, the display control unit 28 merges the two temporary display frames the “rect1” and the “rect2” that overlap, updates the temporary display frames after merge as one temporary display frame, and updates the other temporary display frame as “NULL”.

Returning to step S24 in FIG. 9, the display control unit 28 assigns the number of temporary display frames after the merge processing of the overlapped display frames in step S22 to “N2”. In step S26, the display control unit 28 determines whether the number of temporary display frames before the merge processing of the overlapped display frames in step S22 is equal to the number of temporary display frames after the merge processing of the overlapped display frames.

When the number of temporary display frames before and after the merge processing of the overlapped display frames does not match, the display control unit 28 returns to step S20 and continues the process. When the number of temporary display frames before and after the merge processing of the overlapped display frames match, the display control unit 28 ends the process of FIG. 9. The display control unit 28 repeats the merge processing of the overlapped display frames of the step S22 until the number of the temporary display frames before the merge processing of the overlapped display frames of the step S22 and the number of the temporary display frames after the merge processing of the overlapped display frames of the step S22 match with each other by the process of FIG. 9.

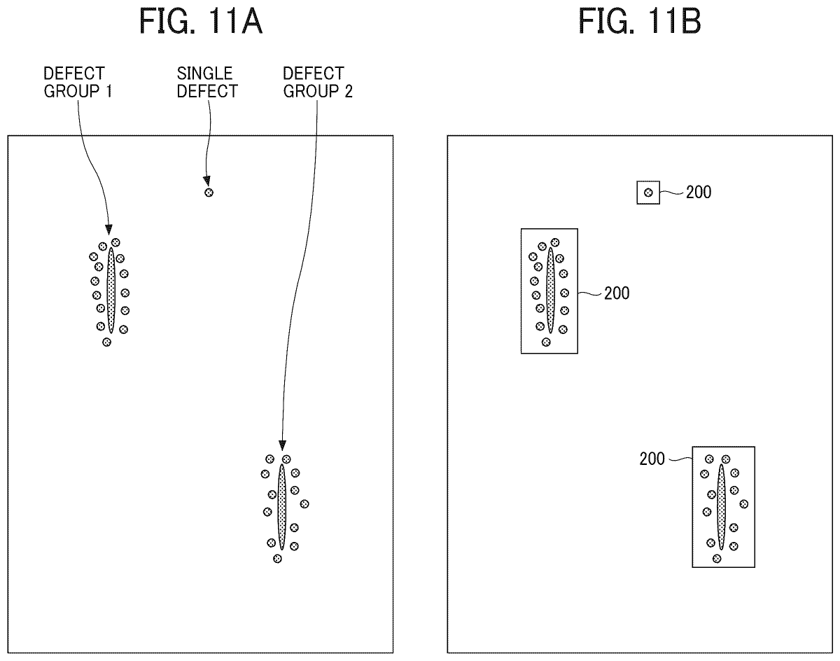

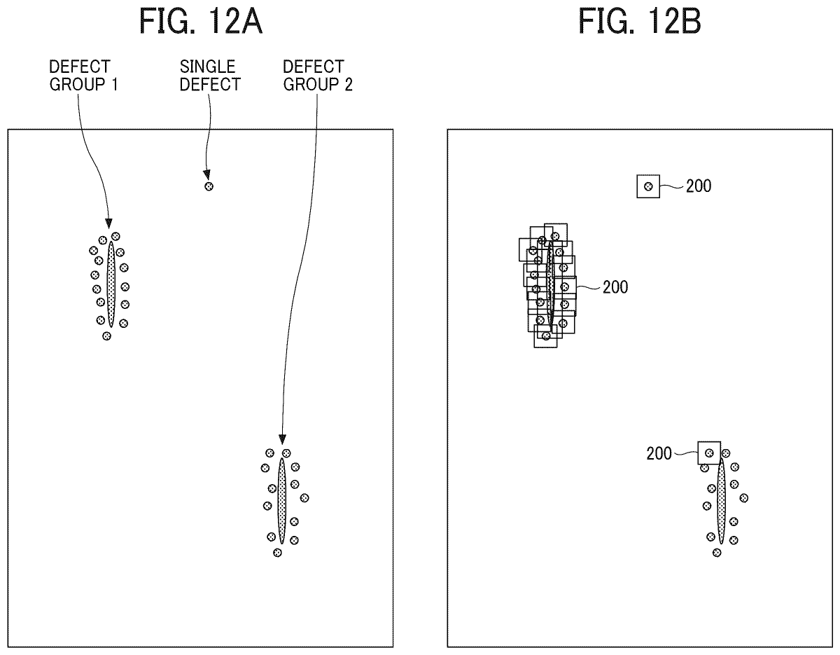

Returning to step S16 in FIG. 5, the display control unit 28 generates a display image. The display control unit 28 generates an image in which the temporary display frame obtained by the processing in steps S10 to S14 is overlapped on the inspection target image data acquired by the inspection target image acquisition unit 20 as the display frame 200 indicating the defective region. FIGS. 11A, 11B, 12A and 12B are diagrams illustrating processes of generating a display image, according to an embodiment of the present disclosure.

FIGS. 11A and 12A are diagrams of examples of the inspection target image displayed the inspection target image data acquired by the inspection target image acquisition unit 20. The inspection target images of FIGS. 11A and 12A include a single defect, a defect group 1, and a defect group 2 as examples of the defective region. FIG. 11B illustrates the temporary display frames obtained by the processing in steps S10 to S14 as the display frame 200 indicating the defective region. FIG. 12B is an example of the display frame 200 indicating the detected defective region by the detection unit 24.

For example, the inspection target image of FIG. 11B includes the display frame 200 of the defect group 1 and the display frame 200 of the defect group 2 after merge. The display frame 200 of the defect group 1 is the display frame after merge, in which the display frames of adjacent defects in the defect group 1 are merged to eliminate overlaps. The display frame 200 of the defect group 2 is the display frame after merge, in which the display frames of adjacent defects in the defect group 2 are merged to eliminate overlaps.

In the inspection image of FIG. 11B, as illustrated in FIG. 12B, the display frame 200 after merge collectively surrounding the defect group 1 is displayed so that the display frames 200 of the defects of the defect group 1 are not displayed in an overlapping manner. As a result, the user can easily visually recognize the defects. Similarly, in the inspection target image of FIG. 11B, the display frame 200 after merge which collectively surrounds the defect group 2 is displayed so that the display frames of the defects of the adjacent defect groups 2 are not displayed in an overlapping manner, and thus the user can easily visually recognize the defects.

As described above, the display control unit 28 can display the display frame after merge in which the display frames having the overlap are merged and the overlap is eliminated instead of the display frames having the overlap so that the display frames are not displayed to overlap each other to display the inspection target image so that the user can easily visually recognize the defect.

FIG. 12B illustrates an example in which the display of the display frame 200 indicating the defective region of the defect group 1 is complicated and difficult to visually recognize. In FIG. 12B, the number of detected defective regions exceeds the upper limit of the display frame 200, and a part of the defective regions of the defect group 2 is not displayed in the display frame 200. With the enhancement in the performance of the algorithm for detecting defects, the number of defective regions to be detected tends to increase, and it is expected that the number of cases where the number of detected defective regions exceeds the upper limit number of the display frame 200 increases.

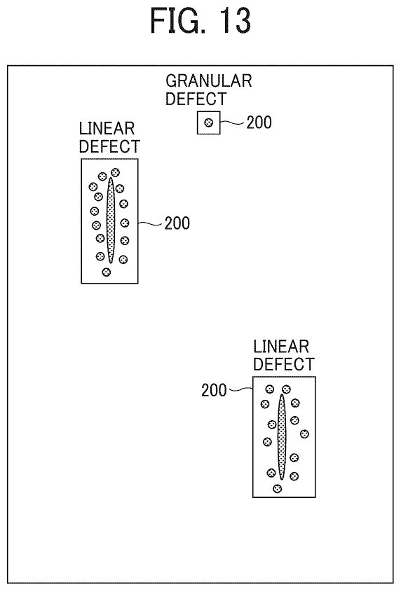

The display control unit 28 according to the present embodiment may display the type of defect determined by the determination unit 26 near the display frame 200 as illustrated in FIG. 13. FIG. 13 is another diagram illustrating processes of generating a display image, according to an embodiment of the present disclosure. As illustrated in FIG. 13, even when a plurality of types of defects are included in the display frame 200, the display control unit 28 displays the type of defect determined by the determination unit 26 as, for example, a representative defect type.

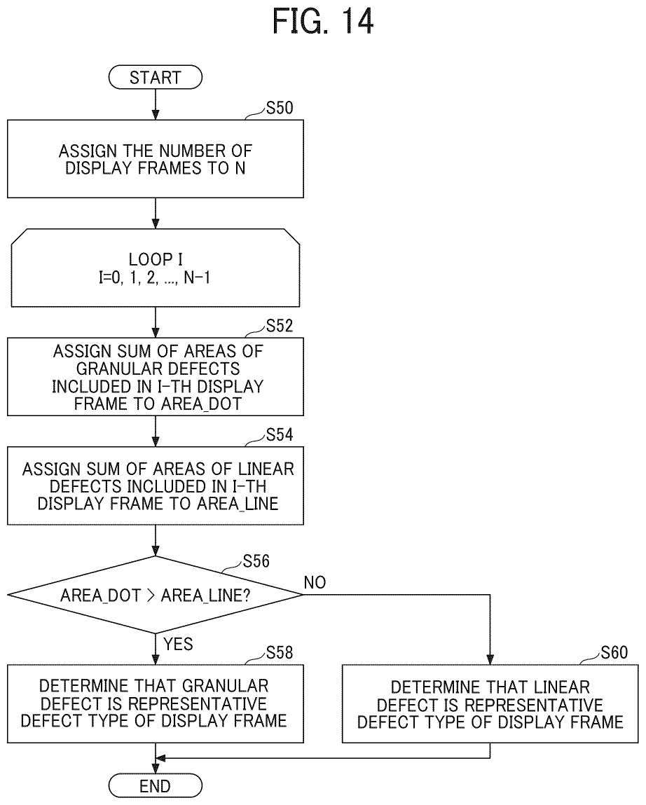

FIG. 14 is a flowchart of a process of the determination unit 26 according to an embodiment of the present disclosure. In step S50, the determination unit 26 assigns the number of display frames to “N”. The determination unit 26 repeats the processing of steps S52 to S60 for each display frame.

In step S52, the determination unit 26 calculates the sum of the areas of the granular defects included in the i-th display frame. In step S54, the determination unit 26 calculates the sum of the areas of the linear defects included in the i-th display frame. In step S56, the determination unit 26 determines whether the sum of the areas of the granular defects calculated in step S52 is larger than the sum of the areas of the linear defects calculated in step S54.

When the sum of the areas of the granular defects calculated in step S52 is larger than the sum of the areas of the linear defects calculated in step S54, the determination unit 26 proceeds to step S58 and determines that the i-th display frame of the granular defect is the representative defect type. When the sum of the areas of the granular defects calculated in step S52 is not larger than the sum of the areas of the linear defects calculated in step S54, the determination unit 26 proceeds to step S60 and determines that the i-th display frame of the linear defect is the representative defect type.

FIG. 13 illustrates an example in which the representative defect type of the display frame is determined based on the sum of the areas of the defects included in the display frame. However, the type of the defect closest to the center of the display frame may be determined as the representative defect type of the i-th display frame.

The representative defect type of the i-th display frame may be a defect type having the largest number of defects included in the i-th display frame. The representative defect type of the i-th display frame may include not only the shape of the defect but also the color of the defect such as a black granular defect or a white linear defect.

In the above description, an example of a defect included in an image obtained by printing a detection target image on a recording medium such as a sheet has been described. The image inspection apparatus 10 according to the present embodiment can also be applied to a comparison of a computed tomography (CT) image, an X-ray image, or an echographic image.

For example, in the case of application to a comparison of the CT images, the image inspection apparatus 10 compares a CT image acquired as an inspection target image with a CT image acquired as a comparison image. When the image inspection apparatus 10 displays a display frame indicating a region having a difference, the image inspection apparatus 10 can display a display frame after merge in which overlapped display frames are merged to eliminate the overlapping.

For example, in the case of application to a comparison of X-ray images, the image inspection apparatus 10 compares an X-ray image acquired as an inspection target image with an X-ray image acquired as a comparison image. When the image inspection apparatus 10 displays a display frame indicating a region having a difference, the image inspection apparatus 10 can display a display frame after merge in which overlapped display frames are merged to eliminate the overlapping.

For example, in the case of application to a comparison of echographic images, the image inspection apparatus 10 compares an echographic image acquired as an inspection target image with an echographic image acquired as a comparison image. When the image inspection apparatus 10 displays a display frame indicating a region having a difference, the image inspection apparatus 10 can display a display frame after merge in which overlapped display frames are merged to eliminate the overlapping.

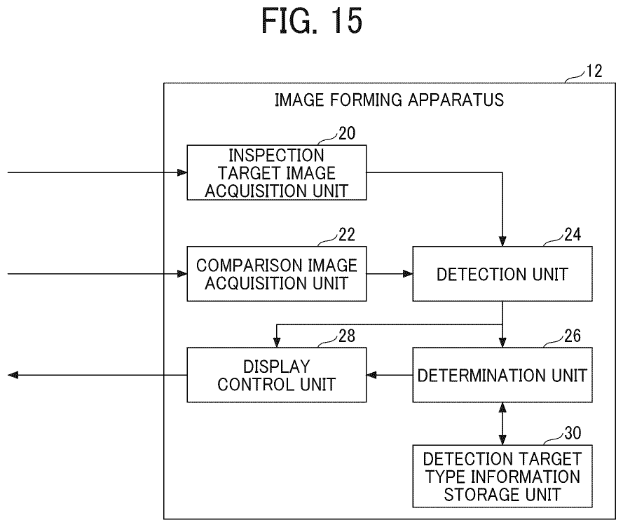

The functions of the image inspection apparatus 10 of FIG. 4 can also be implemented by the image forming apparatus 12 as illustrated in FIG. 15. FIG. 15 is a diagram illustrating a functional configuration of the image forming apparatus 12 according to an embodiment of the present disclosure. The image forming apparatus 12 of FIG. 15 has a configuration having the same function as the image inspection apparatus 10 of FIG. 4.

The inspection target image acquisition unit 20, the comparison image acquisition unit 22, the detection unit 24, the determination unit 26, the display control unit 28, and the detection target type information storage unit 30 of the image forming apparatus 12 are implemented by the CPU 1101 included in the image forming apparatus 12 executing a process defined in programs stored in the ROM 1102a.

The inspection target image acquisition unit 20 acquires inspection target image data. For example, the inspection target image acquisition unit 20 causes the scanner section 1131 to read an image from a recording medium such as a printed sheet to acquire the inspection target image data of the inspection target image. The comparison image acquisition unit 22 acquires comparison image data. The comparison image data is image data used for printing an image on a recording medium such as a sheet.

The detection unit 24 compares the inspection target image data acquired by the inspection target image acquisition unit 20 with the comparison image data acquired by the comparison image acquisition unit 22, and detects a region of the detection target image such as a defect from the inspection image data. The display control unit 28 generates display image data for notifying the user of a detected defective region in the same manner as the image inspection apparatus 10, and causes the operation panel 1140 or the display apparatus 14 to display the display image data. The determination unit 26 determines the type of the detection target image detected by the detection unit 24. The type of the detection target image determined by the determination unit 26 is displayed on the operation panel 1140 or the display apparatus 14 in association with the display frame as described above.

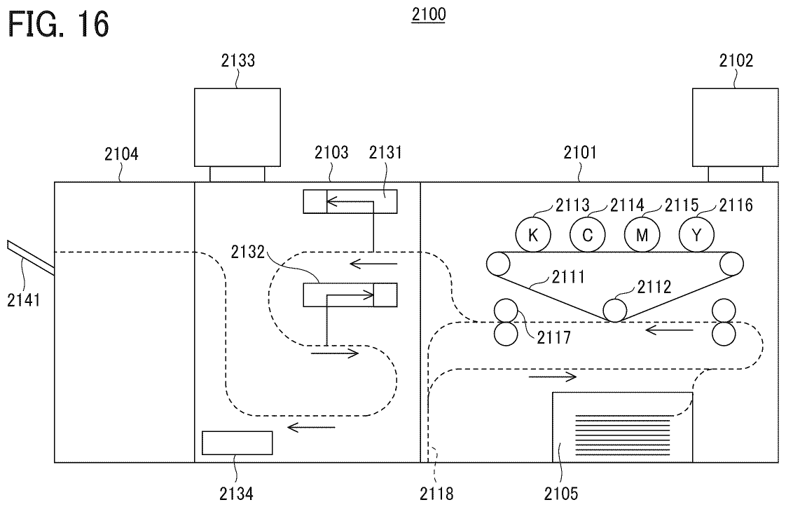

FIG. 16 is a diagram of a printing system 2100 including an image forming apparatus and an image inspection apparatus according to an embodiment of the present disclosure. The system configuration of FIG. 16 is an example, and any configuration may be employed as long as the configuration allows the printing system to detect a defect described in the present embodiment.

The printing system 2100 includes a printer 2101, which is an example of an image forming apparatus, an inspection apparatus 2103, which is an example of an image inspection apparatus, and a stacker 2104. All or two of the printer 2101, the inspection apparatus 2103, and the stacker 2104 may be integrated. The printer 2101 is an apparatus that receives data such as characters, images, or graphics and prints the data on a sheet. The printer 2101 may be referred to as a printing apparatus, a multifunction peripheral, a multifunction printer, or a multifunction product.

The printer 2101 includes an operation unit 2102 that is provided on the upper surface of the printer 2101. The operation unit 2102 includes a display (touch screen) and a keyboard, and displays an operation screen. The operation unit 2102 displays an operation screen of the printing system 2100 and receives various operations from the user.

The printer 2101 receives a print job including a rasterized image processing (RIP) image from an external device such as a digital front end (DFE) or a personal computer (PC), or receives an instruction to execute a print job stored in the printer 2101. In the present embodiment, for example, the RIP image is assumed to be four planes of cyan, magenta, yellow, and black.

The printer 2101 feeds a sheet from a sheet feeder 2105 in accordance with the contents of the print job instructed to be executed, and conveys the sheet along a conveyance passage illustrated by dotted lines in FIG. 16. The printer 2101 forms an image on the sheet by photoconductor drums 2113, 2114, 2115, and 2116. The photoconductor drums 2113, 2114, 2115, and 2116 superimpose toner images of black, cyan, magenta, and yellow on a belt 2111, respectively, transfer the color toner images to the sheet conveyed to a roller 2112, and fix the toner images on the sheet by heat and pressure by a roller 2117. In the case of single-sided printing, the sheet is ejected to an inspection apparatus 2103. In the case of duplex printing, the sheet is reversed in a reversing path 2118, conveyed to the roller 2112, and a color toner image is transferred and fixed to the opposite side of the sheet by the photoconductor drums 2113, 2114, 2115, and 2116, and then the sheet is ejected to the inspection apparatus 2103.

The inspection apparatus 2103 is an apparatus that inspects the print quality of a printed material output by the printer 2101. The inspection apparatus 2103 includes an operation unit 2133 of the inspection apparatus 2103. The operation unit 2133 may have the same function as the operation unit 2102. The inspection apparatus 2103 may not include the operation unit 2133, and the operation unit 2102 of the printer 2101 may also serve as the operation unit. The operation unit 2133 of the inspection apparatus 2103 may be a PC connected via a LAN. In this case, the PC displays the inspection result by using, for example, a web browser or a dedicated application.

The inspection apparatus 2103 causes scanners 2131 and 2132 (examples of a reading unit) to read each side of an image on a sheet ejected from the printer 2101, conveys the sheet in the direction of the arrow of the conveyance passage, and ejects the sheet to the stacker 2104. The inspection apparatus 2103 includes a control unit 2134. The control unit 2134 compares the scanned image with the RIP image and executes defect detection processing. The detection result is displayed on the operation unit 2133.

The stacker 2104 stacks the sheets ejected from the inspection apparatus 2103 on an output tray 2141.

Aspects of the present disclosure are, for example, as follows.

### Aspect 1

An image inspection apparatus for inspecting an inspection target image includes an inspection target image acquisition unit, a detection unit, and a display control unit. The inspection target image acquisition unit acquires inspection target image data. The detection unit compares the acquired inspection target image data with comparison image data and detects a region of a detection target image from the inspection target image. The display control unit displays a display frame indicating the detected region of the detection target image on the inspection target image. The display control unit displays the display frame that overlapped display frames were merged to eliminate overlaps instead of the display frame having the overlaps so that display frames do not overlap.

### Aspect 2

The image inspection apparatus of Aspect 1 further includes a determination unit. The determination unit determines a type of the detection target image detected by the detection unit from types of the detection target images registered in advance and determine the type of the detection target image in the display frame after merge based on a type of the detection target image in the display frame before merge. The display control unit displays the determined type of the detection target image in association with the display frame after merge.

### Aspect 3

In the image inspection apparatus according to Aspect 2, the determination unit calculates an area of the region of the detection target image for each type of the detection target image of the display frame before merge, and determines the type of the detection target image having a largest area as the type of the detection target image of the display frame after merge.

### Aspect 4

In the image inspection apparatus according to Aspect 2, the determination unit determines the type of the detection target image of the display frame before merge, which is closest to a center of the display frame after merge, as the type of the detection target image of the display frame after merge.

### Aspect 5

In the image inspection apparatus according to Aspect 2, the determination unit calculates the number of regions of the detection target image included in the display frame after merge for each type of the detection target image of the display frame before merge and determines the type of the detection target image of the largest number as the type of the detection target image of the display frame after merge.

### Aspect 6

In the image inspection apparatus according to any one of Aspects 1 to 5, the display frame is a predetermined shape.

### Aspect 7

In the image inspection apparatus according to any one of Aspects 1 to 6, the display control unit displays the display frame after merge in which display frames that are closer each other than a predetermined distance are merged in place of the display frames that are closer than the predetermined distance so that the display frames are not displayed close to each other than a predetermined distance.

### Aspect 8

In the image inspection apparatus according to any one of Aspects 1 to 7, the inspection target image acquisition unit reads an image printed on a recording medium as the inspection target image to acquires the inspection target image data. The detection unit compares the inspection target image data with comparison image data which is image data used for the printing, and detects a defective region which is a region of the detection target image from the inspection target image.

### Aspect 9

An image forming apparatus for printing an image on a recording medium and inspecting the image printed on the recording medium as an inspection target image includes an inspection target image acquisition unit, a detection unit, and a display control unit. The inspection target image acquisition unit acquires inspection target image data of the inspection target image. The detection unit compares the acquired inspection target image data with comparison image data which is image data used for the printing and detects a region of a detection target image from the inspection target image. The display control unit displays a display frame indicating the detected region of the detection target image on the inspection target image. The display control unit displays the display frame that overlapped display frames were merged to eliminate overlaps instead of the display frame having the overlaps so that display frames do not overlap.

### Aspect 10

An image inspection method executed by an image inspection apparatus includes: acquiring inspection target image data; comparing the acquired inspection target image data with comparison image data and detecting a region of a detection target image from the inspection target image; displaying a display frame indicating the detected region of the detection target image on the inspection target image; and displaying the display frame that overlapped display frames were merged to eliminate overlaps instead of the display frame having the overlaps so that display frames do not overlap.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), circuitry and/or combinations thereof which are configured or programmed, using one or more programs stored in one or more memories. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image inspection apparatus comprising:
processing circuitry configured to:
acquire inspection target image data;
compare the acquired inspection target image data with comparison image data to detect a plurality of regions of an inspection target image as a plurality of detection target images;
merge a plurality of display frames indicating the plurality of regions detected as the plurality of inspection target images, which are determined to overlap, into a display frame after merge; and
display the display frame after merge on the inspection target image, the display frame including the plurality of regions detected as the plurality of detection target images.

2. The image inspection apparatus according to claim 1,
wherein the processing circuitry is configured to:
determine, for each detection target image, a type of the detection target image in the display frame before merge based on a plurality of types of detection target image registered in advance;
determine a representative type of the detection target images in the display frame after merge based on at least one of the types of the detection target images in the display frame before merge; and
display the determined type of the detection target image after merge in association with the display frame after merge.

3. The image inspection apparatus according to claim 2,
wherein the processing circuitry is configured to:
calculate an area of the detection target image for each type of the detection target image in the display frame before merge; and
determine the type of the detection target image having a largest area as the representative type of the detection target images in the display frame after merge.

4. The image inspection apparatus according to claim 2,
wherein the processing circuitry is configured to determine the type of the detection target image in the display frame before merge, which is located closest to a center of the display frame after merge, as the representative type of the detection target images in the display frame after merge.

5. The image inspection apparatus according to claim 2,
wherein the processing circuitry is configured to calculate a number of the detection target images in the display frame after merge for each type of the detection target image in the display frame before merge, and determine the type of the detection target image having the largest number as the representative type of the detection target image in the display frame after merge.

6. The image inspection apparatus according to claim 1,
wherein the display frame has a predetermined shape.

7. The image inspection apparatus according to claim 1,
wherein the processing circuitry is configured to merge the plurality of display frames that are closer to each other than a predetermined distance into the display frame after merge.

8. The image inspection apparatus according to claim 1,
wherein the processing circuitry is configured to:
acquire the inspection target image data from the inspection target image that is read from an image printed on a recording medium,
the comparison image data being image data used for printing the image to be read; and
detect a defective region of the inspection target image, as the detection target image.

9. A printing system comprising:
a printer to print an image on a recording medium; and
processing circuitry configured to:
acquire inspection target image data from an inspection target image that is read from the printed image;
compare the acquired inspection target image data with comparison image data that is image data used for printing the printed image, to detect a plurality of regions of an inspection target image as a plurality of detection target images;
merge a plurality of display frames indicating the plurality of regions detected as the plurality of inspection target images, which are determined to overlap, into a display frame after merge; and
display the display frame after merge on the inspection target image, the display frame including the plurality of regions detected as the plurality of detection target images.

10. A method of inspecting an image, the method comprising:
acquiring inspection target image data;
comparing the acquired inspection target image data with comparison image data to detect a plurality of regions of an inspection target image as a plurality of detection target images;
merging a plurality of display frames indicating the plurality of regions detected as the plurality of inspection target images, which are determined to overlap, into a display frame after merge; and
displaying the display frame after merge on the inspection target image, the display frame including the plurality of regions detected as the plurality of detection target images.
